(19) United States
(12) Patent Application Publication
(10) Pub. No.: US 2020/0183392 A1
(43) Pub. Date: Jun. 11, 2020

(54) NON-INVASIVE UNIVERSAL ELECTRONIC INTERFACE DEVICE TO TRANSFORM MOBILE INDUSTRIAL VEHICLES INTO AUTONOMOUS DRIVING VEHICLES

(71) Applicant: STOCKED ROBOTICS, INC., Austin, TX (US)

(72) Inventors: Zoltan C. Bardos, Austin, TX (US); Saurav Agarwal, Austin, TX (US)

(73) Assignee: STOCKED ROBOTICS, INC., Austin, TX (US)

(21) Appl. No.: 16/705,698

(22) Filed: Dec. 6, 2019

Related U.S. Application Data
(60) Provisional application No. 62/776,073, filed on Dec. 6, 2018.

(51) Int. Cl. G05D 1/00; H01R 13/66

(52) U.S. Cl. CPC G05D 1/0088; H01R 13/6633; H01R 13/6625

(57) ABSTRACT

A system comprising a first connector configured to be coupled to an assembly having a plurality of electrical signal outputs from user controls of a vehicle. A second connector configured to be coupled to an assembly providing a plurality of inputs to a plurality of vehicle control systems. An interface device configured to process the plurality of electrical signal outputs from user controls of the vehicle and to modify the plurality of electrical signal outputs to generate the plurality of inputs to the plurality of vehicle control systems.

### RELATED APPLICATIONS

The present application claims priority to and benefit of U.S. provisional patent application No. 62/776,073, filed Dec. 6, 2018, which is hereby incorporated by reference as if set forth herein in its entirety.

### TECHNICAL FIELD

The present disclosure relates generally to retrofitting existing mobile industrial vehicles to become autonomous. More particularly, the disclosure relates to a noninvasive electrical interface device configured to retrofit an industrial vehicle with an artificial intelligence system to enable autonomous driving.

### BACKGROUND OF THE INVENTION

Industrial vehicles, such as pallet trucks, forklifts and tuggers among others, are traditionally controlled by a driver operating mechanical wheels, levers, and buttons. These motions are either directly mechanically linked to control mechanisms, or, more commonly, the actions are converted into electrical signals that are interpreted by the computers or electromechanical systems on a vehicle. However, a computer operating with autonomous driving artificial intelligence (AI) software cannot control a vehicle directly. An electrically controlled mobile industrial vehicle is configured to receive electrical commands with of specific types and in specific patterns. A normal computer is not fitted with the correct hardware to enable such signaling.

### SUMMARY OF THE INVENTION

A system is disclosed that includes a first connector that is configured to be coupled to an assembly having a plurality of electrical signal outputs from user controls of a vehicle, such as a preexisting connector of a vehicle electrical system. A second connector is configured to be coupled to an assembly that provides a plurality of inputs to a plurality of vehicle control systems. An interface device is configured to process the plurality of electrical signal outputs from user controls of the vehicle and to modify the plurality of electrical signal outputs to generate the plurality of inputs to the plurality of vehicle control systems.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings may be to scale, but emphasis is placed upon clearly illustrating the principles of the present disclosure. Moreover, in the drawings, like reference numerals designate corresponding parts throughout the several views, and in which:

FIG. 1 is a diagram of an interface device 100, in accordance with an example embodiment of the present disclosure;

FIG. 2 is a diagram 200 of an example installation process for incorporating an interface device 202 into a vehicle's wiring harness, in accordance with an example embodiment of the present disclosure; and

FIG. 3 is a wiring diagram 300 of an interface device printed circuit board (PCB) with integrated circuits (ICs), in accordance with an example embodiment of the present disclosure.

### DETAILED DESCRIPTION OF THE INVENTION

In the description that follows, like parts are marked throughout the specification and drawings with the same reference numerals. The drawing figures may be to scale and certain components can be shown in generalized or schematic form and identified by commercial designations in the interest of clarity and conciseness.

The present disclosure is directed to a universally configurable, minimally invasive, electrical interface device that can be used to integrate an autonomous driving AI system with the electrical control system of a mobile industrial vehicle. The electrical interface device can be referred to as the “interface device.” The interface device can be provided with a robust selection of electrical input and output signal types to make it universal, and to allow the interface device to interface with a variety of vehicle types and control signal configurations. The interface device can include protected electrical inputs and outputs for vehicle control, power control, control of peripheral devices, communication ports for interfacing with the autonomous driving AI system it supports, and a main programmable logic core.

The system diagrams, technologies, and vehicles mentioned and shown in the following paragraphs and diagrams are simplified specific examples shown to explain the disclosed concept and design.

The present disclosure facilitates installation of an AI system that enables autonomous driving and which can be retrofitted into an existing vehicle, by integrating the AI system with the vehicle in a number of ways. In one example embodiment, customized electromechanical devices can be used to duplicate human movements, such as interacting with buttons, levers, and wheels. However, this configuration can be complicated, invasive and expensive.

Another example embodiment is to use a discrete electrical device which can be installed in an existing vehicle electrical system, and which can interrupt electrical control signals generated by the human driver controls and replace them with signals generated by an electrical interface device in communication with the AI system. In this example embodiment, the device can be configured to interface with the control signals via one of the many connection points on a wiring harness on a vehicle. The device can be positioned as such in the stream of driver control signals and can offer multiple modes of operation when working with an AI system that enables autonomous driving.

In one mode of operation, the electronic interface device can be configured to ignore all human activated control signals, and to instead generate control signals commanded by the AI system, to enable autonomous driving. In another mode of operation, the device can be configured to read in control signals having a predetermined format and output modified control signals using the same format, or to modify the control signals in response to inputs from a user interface, such as to provide manual control of the vehicle or for other suitable purposes. The electronic interface device can be provided with a sufficient variety of electrical input and output types so as to be considered universal, to enable it to be configured to interface with electrically controlled vehicles.

Vehicles configured for manual human control typically exhibit a predetermined number of modes of control, which can include 1) throttling forward and backward, 2) braking, 3) turning a steering wheel clockwise or counterclockwise, 4) moving vehicle mechanisms associated with tilt, yaw, and altitude of a manipulator, 5) activating alert signals such as a horn or flashing lights, or other suitable controls. Therefore, the electrical interface device can be configured to utilize the predetermined types of controls and ranges of outputs associated with these common modes of industrial vehicle control, to enable straightforward transformation of commercially available types of industrial vehicles into autonomous driving vehicles. In addition, the electrical interface device can be configured to be easily modified, to accommodate future technologies or discoveries.

Another advantage of the electrical interface of the present disclosure is that it facilitates a method of vehicle control that does not require any mechanical alterations to the vehicle or its drive systems, and which only requires an electrical connection to the vehicle's existing wiring harness. The disclosed configuration allows the vehicle to remain largely unaltered from its original condition, and allows the retrofit to be easily reversed, such as to remove the retrofitted AI control system for installation on a different vehicles, and to allow the vehicle to be sold to users for manual control applications.

The present disclosure includes a minimally invasive electrical interface device that integrates with a mobile industrial vehicle's wiring harness to enable an AI system to enable autonomous driving, to generate or mimic drive control signals, to transform a mobile industrial vehicle into an autonomous vehicle and for other suitable purposes.

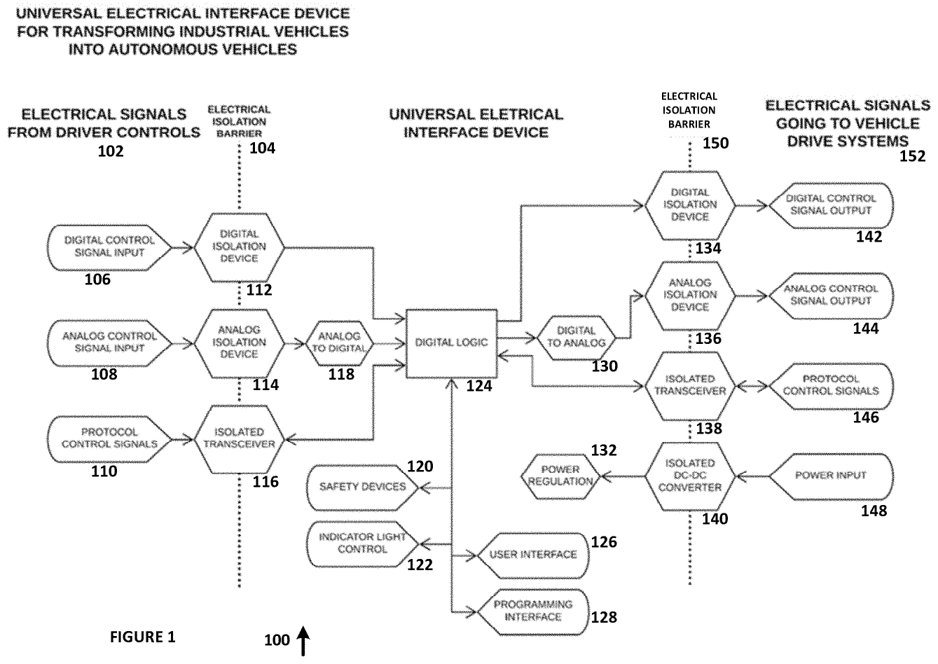

FIG. 1 is a diagram of an interface device 100, in accordance with an example embodiment of the present disclosure. Interface device 100 includes electrical signals from driver controls 102, electrical isolation barrier 104, digital control signal input 106, analog control signal input 108, protocol control signals 110, digital isolation device 112, analog isolation device 114, isolated transceiver 116, analog to digital converter 118, digital logic 124, safety devices 120, indicator light controls 122, user interface 126, programming interface 128, digital to analog converter 130, digital isolation device 134, analog isolation device 136, isolated transceiver 138, isolated DC-DC converter 140, digital control signal output 142, analog control signal output 144, protocol control signals 146, power input 148, electrical isolation device 150 and electrical signals going to vehicle drive systems 152, each of which can be implemented in hardware or a suitable combination of hardware and software.

Electrical signals from driver controls 102 can include analog signals, digital signals and other suitable signals that are used to control the operation of a vehicle. In one example embodiment, the controls can be provided using dedicated wiring for each control signal, using time division multiplexed analog or digital signals, using frequency division multiplexed analog or digital signals or in other suitable manners.

Electrical isolation barrier 104 can be implemented using a capacitor, a transformer, an electrical to optical converter or other suitable devices or systems. In one example embodiment, electrical isolation barrier 104 can include a predetermined voltage withstand rating that is selected as a function of the expected voltages that the system might generate under a fault condition or in other suitable configurations.

Digital control signal input 106 can receive signals that are compliant with a universal serial bus (USB) input, an Ethernet input, a peripheral component interconnect (PCI) input, a PCI Express input or other suitable digital input protocols. In one example embodiment, the data provided to digital control signal input 106 can be provided using time division multiplexed digital signals, using frequency division multiplexed digital signals or in other suitable manners. The digital control signals can be provided using high and low voltage state changes to signal an event or action. For example, for a horn control, a digital value of ‘0’, corresponding to a signal wire voltage of 0V, could be used to indicate ‘horn off’ and a digital value of ‘1’, corresponding to a signal wire voltage of 24V, could be used to indicate ‘horn on.’ Other suitable signals can also or alternatively be used.

Analog control signal input 108 can receive signals that are provided over one or more twisted pairs, one or more coaxial cables or other suitable analog input protocols. In one example embodiment, the data provided to analog control signal input 108 can be provided using time division multiplexed analog signals, using frequency division multiplexed analog signals or in other suitable manners. The analog control signals can include a continuous range of voltage levels. For example, a throttle control might be signaled linearly in analog, with 0 volts indicating a minimum throttle setting, 12 volts indicating a full throttle setting, and where a suitable value in between exists and represents a corresponding throttle level.

Protocol control signals 110 can receive one or more control signals that are compliant with a predetermined protocol, such as AFDX, ARINC 429, Byteflight, Controller Area Network (CAN), Domestic Digital Bus (D2B), FlexRay, DC-BUS, IDB-1394, IEBus, I²Cm, ISO 9141-1/-2, J1708, J1587, J1850, J1939, ISO 11783, Keyword Protocol 2000 (KWP2000), Local Interconnect Network (LIN), Media Oriented Systems Transport (MOST), Multifunction Vehicle Bus, IEC 61375, SMARTwireX, SPI, Vehicle Area Network (VAN) or other suitable protocols.

Digital isolation device 112 can be implemented using a capacitor, a transformer, an electrical to optical converter or other suitable devices or systems. In one example embodiment, electrical isolation barrier 112 can include a predetermined voltage withstand rating that is selected as a function of the expected voltages that the system might generate under a fault condition or in other suitable configurations.

Analog isolation device 114 can be implemented using a capacitor, a transformer, an electrical to optical converter or other suitable devices or systems. In one example embodiment, analog isolation device 114 can include a predetermined voltage withstand rating that is selected as a function of the expected voltages that the system might generate under a fault condition or in other suitable configurations.

Isolated transceiver 116 can be configured to provide electrical isolation for signals received from protocol control signals 110 and provided to digital logic 124. Isolated transceiver 116 can be implemented using a capacitor, a transformer, an electrical to optical converter or other suitable devices or systems. In one example embodiment, isolated transceiver 116 can include a predetermined voltage withstand rating that is selected as a function of the expected voltages that the system might generate under a fault condition or in other suitable configurations.

Analog to digital converter 118 can be implemented in hardware or a suitable combination of hardware and software and can be one or more integrated circuits. In one example embodiment, analog to digital converter 118 can be configured to receive an analog signal having predetermined frequency and voltage characteristics and to convert the analog signal into a digital signal having a predetermined number of bits and encoding protocol.

Digital logic 124 can be implemented in hardware or a suitable combination of hardware and software and can be one or more software applications operating on a processor and configured to provide vehicle control functions, AI data processing or other suitable data processing. Digital logic 124 can be updated using convention logic updating techniques and data security. In one example embodiment, digital logic can include an interface to a local or remote AI system having functionality disclosed in U.S. provisional patent application 62/859,999, filed Jun. 11, 2019, U.S. provisional patent application 62/776,073, filed Dec. 6, 2018, U.S. provisional patent application 62/743,584, filed Oct. 10, 2018, U.S. provisional patent application 62/620,819, filed Jan. 23, 2018, U.S. provisional patent application 62/589,900, filed Nov. 22, 2017, U.S. provisional patent application 62/582,739, filed Nov. 7, 2017, U.S. utility patent application Ser. No. 16/597,723, filed Oct. 9, 2019, U.S. utility patent application Ser. No. 16/255,399, filed Jan. 23, 2019, U.S. utility patent application Ser. No. 16/198,579, filed Nov. 21, 2018 and U.S. utility patent application Ser. No. 16/183,592, filed Nov. 7, 2018, each of which is hereby incorporated by references for all purposes as if set forth herein in its entirety.

Safety devices 120 can receive and transmit data and controls used to operate safety devices of a vehicle, such as brake lights, horns, turn indicators, audible signal generators, image data processing systems and other suitable systems. In one example embodiment, safety devices 120 can be used to indicate when a vehicle is under automatic control or other suitable information. The safety devices can include hardware devices such as vehicle detection scanners, emergency stop buttons, manual override switches and other suitable devices.

Indicator light controls 122 can receive and transmit data and controls used to operate indicators of a vehicle, such as brake lights, turn indicators, tower lights, beacon lights, safety lights used to alert people nearby that an autonomous vehicle is operating and other suitable systems. In one example embodiment, indicator light controls 122 can be used to indicate when a vehicle is under automatic control or other suitable information.

User interface 126 can be implemented using a personal computer, a wearable control, a touch screen device, an application operating on a smart telephone, switches, buttons or in other suitable manners. In one example embodiment, user interface 126 can receive and transmit control data to digital logic 124, can generate one or more user interface controls and displays to allow a user to determine a state of a vehicle and to control an action of the vehicle or can perform other suitable functions.

Programming interface 128 can be implemented in hardware or a suitable combination of hardware and software, and can modify, update, delete or replace one or more algorithms contained within digital logic 124, or can allow a technician to program, update, configure, debug or otherwise interact with interface device 102. In one example embodiment, programming interface 128 can include security devices that prevent unauthorized access to digital logic 124 and other suitable functionality.

Digital to analog converter 130 can be implemented in hardware or a suitable combination of hardware and software and can be one or more integrated circuits. In one example embodiment, digital to analog converter 130 can be configured to receive a digital signal having a predetermined number of bits and encoding protocol and to convert the digital signal into an analog signal having predetermined frequency and voltage characteristics.

Digital isolation device 134 can be implemented using a capacitor, a transformer, an electrical to optical converter or other suitable devices or systems. In one example embodiment, digital isolation device 134 can include a predetermined voltage withstand rating that is selected as a function of the expected voltages that the system might generate under a fault condition or in other suitable configurations.

Analog isolation device 136 can be implemented using a capacitor, a transformer, an electrical to optical converter or other suitable devices or systems. In one example embodiment, analog isolation device 136 can include a predetermined voltage withstand rating that is selected as a function of the expected voltages that the system might generate under a fault condition or in other suitable configurations.

Isolated transceiver 138 can be configured to provide electrical isolation for signals received from digital logic 124 and provided to protocol control signals 146. Isolated transceiver 138 can be implemented using a capacitor, a transformer, an electrical to optical converter or other suitable devices or systems. In one example embodiment, isolated transceiver 138 can include a predetermined voltage withstand rating that is selected as a function of the expected voltages that the system might generate under a fault condition or in other suitable configurations.

Isolated DC-DC converter 140 can include one or more DC to DC converters that are configured to provide electrical isolation to power regulation 132.

Digital control signal output 142 can generate output signals that are compliant with a universal serial bus (USB) output, an Ethernet output, a peripheral component interconnect (PCI) output, a PCI Express output or other suitable digital output protocols. In one example embodiment, the data generated using digital control signal output 142 can be generated using time division multiplexed digital signals, using frequency division multiplexed digital signals or in other suitable manners.

Analog control signal output 144 can generate output signals using one or more twisted pairs, one or more coaxial cables or other suitable analog output protocols. In one example embodiment, the output data provided using analog control signal output 144 can be generated using time division multiplexed analog signals, using frequency division multiplexed analog signals or in other suitable manners.

Protocol control signals 146 can generate one or more control signal outputs that are compliant with a predetermined protocol, such as AFDX, ARINC 429, Byteflight, Controller Area Network (CAN), Domestic Digital Bus (D2B), FlexRay, DC-BUS, IDB-1394, IEBus, I²Cm, ISO 9141-1/-2, J1708, J1587, J1850, J1939, ISO 11783, Keyword Protocol 2000 (KWP2000), Local Interconnect Network (LIN), Media Oriented Systems Transport (MOST), Multifunction Vehicle Bus, IEC 61375, SMARTwireX, SPI, Vehicle Area Network (VAN) or other suitable protocols.

Power input 148 can be configured to plug into a vehicle DC power supply or can use other suitable connectors or configurations. In one example embodiment, power input 148 can use one or more common vehicle power system interface devices or other suitable devices.

Electrical isolation device 150 can be implemented using a capacitor, a transformer, an electrical to optical converter or other suitable devices or systems. In one example embodiment, electrical isolation device 150 can include a predetermined voltage withstand rating that is selected as a function of the expected voltages that the system might generate under a fault condition or in other suitable configurations.

Electrical signals going to vehicle drive systems 152 can be configured to simulate the electrical signal formats and levels that are typically generated, and include additional signal processing and control in response to digital logic 124, user interface 126, programming interface 128 and other processes and inputs. In this manner, the vehicle can be provided with AI control or other suitable automation.

The flow of control signals, data, and power through interface device 100 can include the following example functional components. The system diagram is separated into three portions by electrical isolation barriers. In the left most portion of the system diagram, electrical signals from driver controls 102 can include driver control signals arriving in response to user inputs from driver control mechanisms such as the steering handle, buttons, and switches. These signals can arrive in predetermined formats, as shown. Interface device 100 can include a predetermined number of each input type to enable it to successfully interface with different industrial vehicle configurations. For example, a Crown PC4500 pallet jack truck control handle can transmit ten different electrical signals of mixed analog and digital types for driving commands such as forks up, forks down, forward, back, steering, brake, and horn, and interface device 100 can be configured to receive these and other common control and data signals.

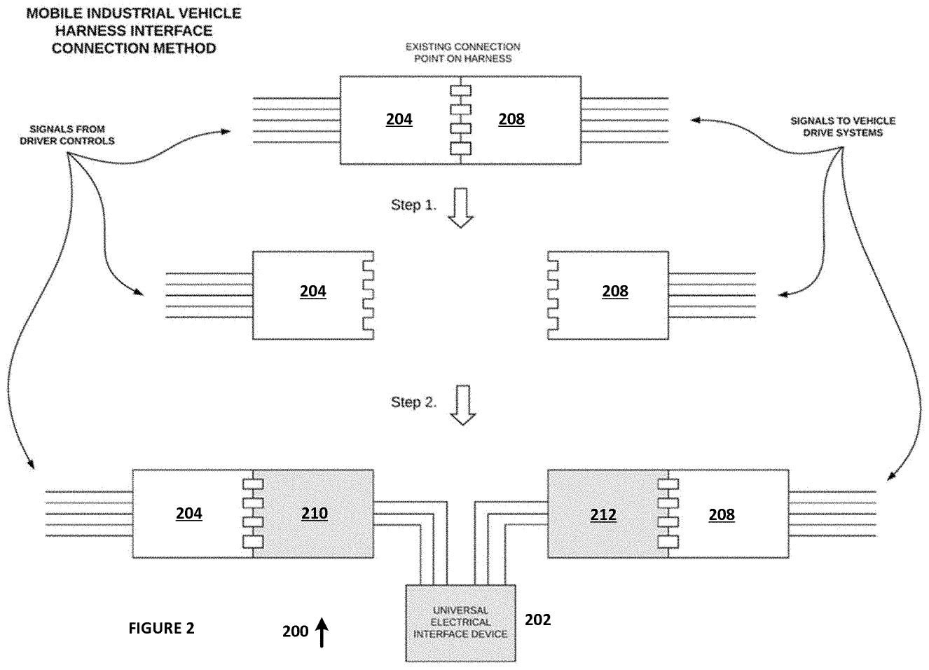

FIG. 2 is a diagram 200 of an example installation process for incorporating an interface device 202 into a vehicle's wiring harness, in accordance with an example embodiment of the present disclosure. Diagram 200 includes connectors 204 and 208 of an existing connection point on a harness, which can be disconnected in step 1 and connected to connectors 210 and 212 of universal electrical interface device 202. The connection process can be performed when the vehicle is not active, to prevent potential misoperation of one or more systems of the vehicle, and can include a failsafe signal that disables the vehicle when connectors 204 and 208 are disconnected, and which only allows predetermined connectors 210 and 212 to be reconnected.

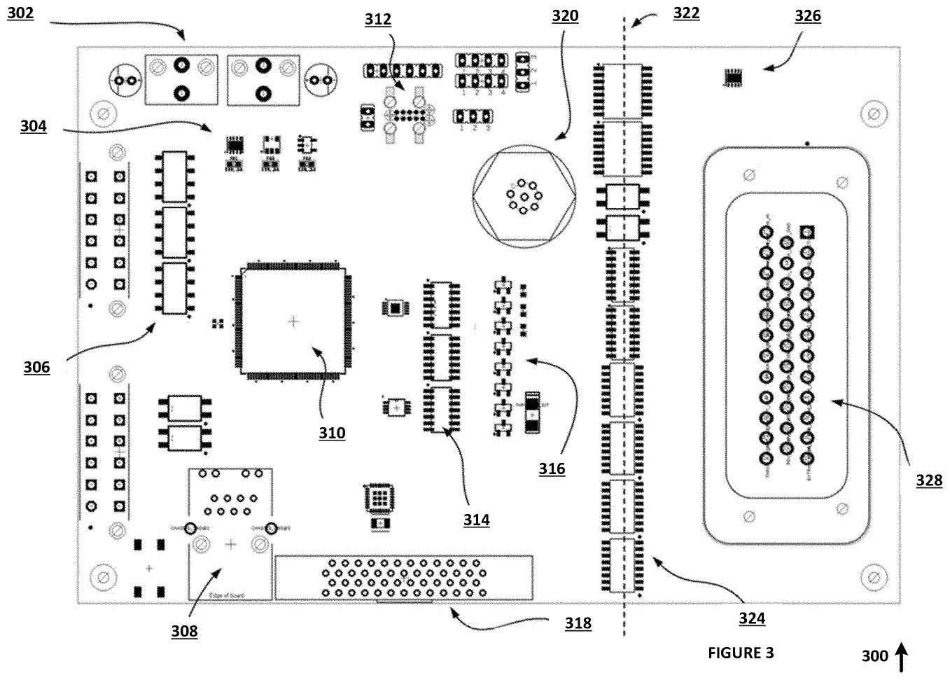

FIG. 3 is a wiring diagram 300 of an interface device PCB with ICs, in accordance with an example embodiment of the present disclosure. In one example embodiment, wiring diagram 300 can be used for a Crown PC4500 or Raymond 8500 model of pallet jacks or other suitable devices.

Power input connections 302 are configured to provide power to board power regulator integrated circuit 304, and to select peripherals via high power solid state relays 306. An Ethernet port 308 can be used to provide data communication between an interface device, such as interface device 100 or interface device 202, and a processor configured to operate one or more autonomous driving enabling software algorithms. The data communications can be decoded, and logic executed by the microprocessor 310, which can be programmed using interface connections 312 or in other suitable manners.

Analog control signals that enter and exit the interface device can be processed by analog signal processing integrated circuits and discrete analog circuitry 314 with added circuit protection 316 to protect against over voltage and over current events. Digital isolation devices 324 and CAN bus protocol isolation devices 324 are placed along an electrical isolation barrier 322 and are configured to perform input and output functionality. Isolation devices 324 can be configured to receive electric power from isolated power sources, such as 5V regulator 326.

A safety scanner or other suitable safety devices can be configured to provide emergency stop signals and other suitable signals via M12 connector 320. Vehicle control signals can be received from and transmitted back to the vehicle via a hermetically sealed, ingress protected 35 pin connector 328. Control signals can also be redundantly offered on connector 318 for the purpose of system testing after manufacturing.

A minimally invasive, universal electrical interface device is disclosed for transforming mobile industrial vehicles into autonomous driving vehicles. The electrical system can be configured to interface with control signals of a mobile industrial vehicle that includes one or more of an isolated digital control signal input interface, an isolated digital control signal output interface, an analog control signal input interface, an analog control signal output interface, isolated CAN bus protocol transceivers, isolated Ethernet protocol transceivers, isolated power conversion, a microcontroller and isolated solid state relays. The interface device can be configured to communicate with an autonomous driving enabling AI system, an can be further configured to translate commands from an autonomous driving enabling AI system into electrical signals interpreted by the industrial vehicle. The interface device can be further configured to measure and interpret electrical signals originating from the manual driver controls as specific driving actions, and to communicate measured driving actions to an autonomous driving enabling AI system.

The disclosed system is universal and can be mounted on different vehicle models with different configurations using the same hardware. The interface device can be minimally invasive, utilizing existing wiring harness connection points on the vehicle, and can be easily removed and the vehicle will be reverted to its original condition.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes one or more microcomputers or other suitable data processing units, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections. The term “data” can refer to a suitable structure for using, conveying or storing data, such as a data field, a data buffer, a data message having the data value and sender/receiver address data, a control message having the data value and one or more operators that cause the receiving system or component to perform a function using the data, or other suitable hardware or software components for the electronic processing of data.

In general, a software system is a system that operates on a processor to perform predetermined functions in response to predetermined data fields. A software system is typically created as an algorithmic source code by a human programmer, and the source code algorithm is then compiled into a machine language algorithm with the source code algorithm functions, and linked to the specific input/output devices, dynamic link libraries and other specific hardware and software components of a processor, which converts the processor from a general purpose processor into a specific purpose processor. This well-known process for implementing an algorithm using a processor should require no explanation for one of even rudimentary skill in the art. For example, a system can be defined by the function it performs and the data fields that it performs the function on. As used herein, a NAME system, where NAME is typically the name of the general function that is performed by the system, refers to a software system that is configured to operate on a processor and to perform the disclosed function on the disclosed data fields. A system can receive one or more data inputs, such as data fields, user-entered data, control data in response to a user prompt or other suitable data, and can determine an action to take based on an algorithm, such as to proceed to a next algorithmic step if data is received, to repeat a prompt if data is not received, to perform a mathematical operation on two data fields, to sort or display data fields or to perform other suitable well-known algorithmic functions. Unless a specific algorithm is disclosed, then any suitable algorithm that would be known to one of skill in the art for performing the function using the associated data fields is contemplated as falling within the scope of the disclosure. For example, a message system that generates a message that includes a sender address field, a recipient address field and a message field would encompass software operating on a processor that can obtain the sender address field, recipient address field and message field from a suitable system or device of the processor, such as a buffer device or buffer system, can assemble the sender address field, recipient address field and message field into a suitable electronic message format (such as an electronic mail message, a TCP/IP message or any other suitable message format that has a sender address field, a recipient address field and message field), and can transmit the electronic message using electronic messaging systems and devices of the processor over a communications medium, such as a network. One of ordinary skill in the art would be able to provide the specific coding for a specific application based on the foregoing disclosure, which is intended to set forth exemplary embodiments of the present disclosure, and not to provide a tutorial for someone having less than ordinary skill in the art, such as someone who is unfamiliar with programming or processors in a suitable programming language. A specific algorithm for performing a function can be provided in a flow chart form or in other suitable formats, where the data fields and associated functions can be set forth in an exemplary order of operations, where the order can be rearranged as suitable and is not intended to be limiting unless explicitly stated to be limiting.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A system comprising:
a first connector configured to be coupled to an assembly having a plurality of electrical signal outputs from user controls of a vehicle;
a second connector configured to be coupled to an assembly providing a plurality of inputs to a plurality of vehicle control systems; and
an interface device configured to process the plurality of electrical signal outputs from user controls of the vehicle and to modify the plurality of electrical signal outputs to generate the plurality of inputs to the plurality of vehicle control systems.

2. The system of claim 1 wherein the first connector further comprises an electrical isolation barrier.

3. The system of claim 2 wherein the electrical isolation barrier comprises a digital isolation device and an analog isolation device.

4. The system of claim 2 wherein the electrical isolation barrier comprises a digital isolation device and an isolated protocol transceiver.

5. The system of claim 1 wherein the second connector further comprises an electrical isolation barrier.

6. The system of claim 1 wherein the interface device comprises programmable logic configured to modify the plurality of electrical signal outputs to generate the plurality of inputs to the plurality of vehicle control systems in response to one or more safety device signals.

7. The system of claim 1 wherein the interface device comprises programmable logic configured to generate one or more indicator signals in response to one or more safety device signals.

8. The system of claim 1 wherein the interface device comprises programmable logic configured to receive control signals from a user interface device and to modify the plurality of electrical signal outputs to generate the plurality of inputs to the plurality of vehicle control systems as a function of the control signals from the user interface device.
